(19) United States
(12) Patent Application Publication
(10) Pub. No.: US 2022/0078302 A1
(43) Pub. Date: Mar. 10, 2022

(54) MEDIA SCANNER

(71) Applicant: Hewlett-Packard Development Company, L.P., Spring, TX (US)

(72) Inventors: Shannon Lai, San Diego, CA (US); Ryan M. Smith, San Diego, CA (US); Rene Octavio Valenzuela-Rivas, San Diego, CA (US)

(73) Assignee: Hewlett-Packard Development Company, L.P., Spring, TX (US)

(21) Appl. No.: 17/294,456

(22) PCT Filed: Apr. 30, 2019
(86) PCT No.: PCT/US2019/029992

§ 371 Date: May 17, 2021

(51) Int. Cl. H04N 1/00; H04N 1/203; H04N 1/10; H04N 1/12

(52) U.S. Cl. CPC H04N 1/00909; H04N 1/00588; H04N 1/125; H04N 1/1008; H04N 1/2032

(57) ABSTRACT

A media scanner including an input tray, an output tray disposed above the input tray, a media feeder to advance media along a media path from the input tray to the output tray, an upper scanning device to generate a first scan line, and a lower scanning assembly. The upper scanning device is disposed to face downward to scan a first side of the media. The lower scanning assembly is disposed to face upward to scan a second side of the media. The media path extends from the input tray to below the upper scanning device, to above the lower scanning assembly, and to the output tray. The upper scanning device is disposed at an angle with respect to the media path to cause a front edge of the media advancing along the media path to contact the upper scanning device at or before the first scan line.

### BACKGROUND

Media scanning devices are typically used to scan and convert physical documents or photographs (generally referred to herein as “media”) into a digital format, such as, for example, a digital file. Once converted, the digital file may be more easily stored and shared via electronic devices (e.g., computers, servers, smartphones, tablets, etc.)

Some media scanning devices, including multifunction printers (MFPs) and other devices, are capable of scanning, converting, and reproducing (e.g. print) two-sided documents. In some cases, these devices use two separate scanning devices to scan both sides of the document as the document is fed through the automatic document feeder (ADF) of the device.

### BRIEF DESCRIPTION OF THE DRAWINGS

FIG. 1 is a perspective view of a media scanner according to an example;

FIG. 2 is a side view of a printing and scanning device including the media scanner of FIG. 1 according to an example;

FIG. 3 is a perspective view of a scanning device configured to advance media along a C-path in the related art;

FIG. 4 is a perspective view of a scanning device configured to advance media along an inverted C-path according to an example;

FIG. 5 is a zoomed in perspective view of the scanning device in FIG. 4 according to an example;

FIG. 6 is a detailed view of the upper scanning device in FIGS. 4-5 according to an example.

### DETAILED DESCRIPTION

Various examples of the disclosure will now be described in greater detail with reference to the accompanying drawings, wherein like reference characters denote like elements. Examples to be explained in the following may be modified and implemented in various different forms.

When it is stated in the disclosure that one element is “connected to” or “coupled to” another element, the expression encompasses not only an example of a direct connection or direct coupling, but also a connection with another element interposed therebetween. Further, when it is stated herein that one element “includes” another element, unless otherwise stated explicitly, it means that yet another element may be further included rather than being excluded.

As used herein, including in the claims, the word “or” is used in an inclusive manner. For example, “A or B” means any of the following: “A” alone, “B” alone, or both “A” and “B”.

Within the context of this disclosure, the “first” or “front” side of a document to be scanned is understood to be the side of the document that faces upward or outward (e.g., is visible) when the document is fed into an automatic document feeder of a scanning device. The “second” or “back” side of the document to be scanned is the side of the document that faces downward or inward (e.g., is not visible) when the document is fed into the ADF.

Media scanners may be used to digitize some types of media. In some circumstances, media scanners may include an ADF that is to draw media from an input tray, traverse the media past one or more scanning devices, and then dispense the media into an output tray.

In one example, a media scanner may include an input tray, an output tray, a media feeder, an upper scanning device, and a lower scanning device. Some scanning devices that are capable of reproducing two-sided documents position include two separate scanning devices, such as the upper scanning device and the lower scanning device. The document to be scanned then passes between the respective scan lines of the upper scanning device, and the lower scanning device, and each scanning device scans (along its respective scan line) one side of the document. This configuration shortens the paper path through the ADF of the scanning device and reduces the overall device size. However, this configuration has also been shown to accumulate dust and debris to the upper scanning device and to the lower scanning device. This accumulation of dust and debris causes the appearance of undesirable streaks in the scanned image or printed copy of the media.

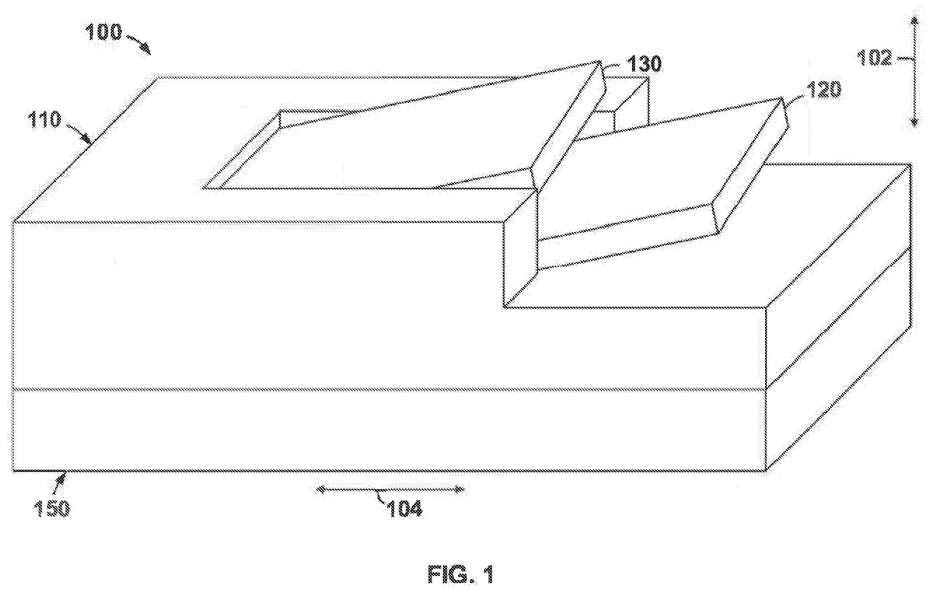

FIG. 1 shows a view of a media scanner 100 according to an example. The media scanner 100 may include a first or upper housing 110, and a second or lower housing 150 coupled to upper housing 110. The upper housing 110 supports an input tray 120 and an output tray 130. In particular, as shown in FIG. 1, input tray 120 is disposed vertically lower than output tray 130 with respect to the vertical direction 102. In addition, in this example, output tray 130 is laterally shifted relative to input tray 120 along the lateral direction 104 such that output tray 130 is disposed over a portion of input tray 120. In particular, in this example, output tray 130 is laterally shifted relative to input tray 120 along lateral direction 104 so that a majority (more than 50%) of input tray 120, such as, for example, a majority of the surface area of input tray 120, is exposed as viewed in the vertical direction 102. In other examples, the output tray 130 may be further shifted relative to input tray 120 in the lateral direction 104 so that output tray 130 may not extend over any portion of input tray 120, and input tray 120 is fully or totally exposed as viewed in the vertical direction 102. In addition, in still other examples, output tray 130 may not be laterally shifted relative to input tray 120 such that output tray 130 is disposed over the entirety of input tray 120. Using an ADF, the media scanner 100 may automatically draw media disposed on the input tray 120 into and along an inverse C-path media path that extends over a plurality of scanning devices (not shown in FIG. 1), and then dispense the media onto output tray 130.

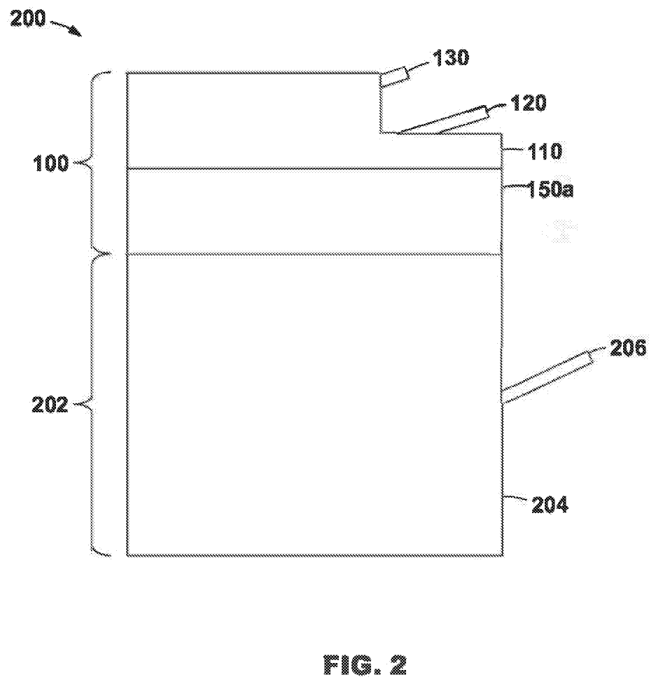

FIG. 2 shows a view of a printing and scanning device 200 according an example. The printing and scanning device 200 includes the media scanner 100 as previously described and a printer 202 coupled to media scanner 100.

The printer 202 may comprise any suitable device for placing or affixing an image onto a recording medium. For example, the printer 202 may comprise an inkjet printer, a laser printer, etc. In this example, the printer 202 includes a printer housing 204 and an output tray 206 for receiving media following a printing operation.

The printing and scanning device 200 may scan a piece of media using the media scanner 100. The printing and scanning device 200 may print images upon a recording medium, such as, but not limited to, paper, via the printer 202.

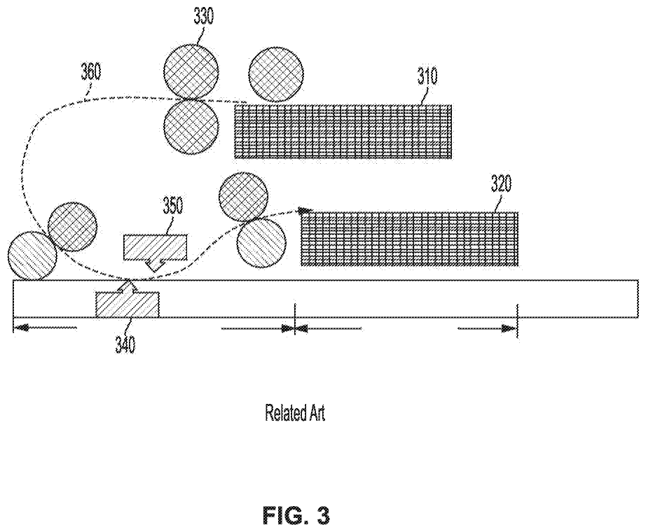

FIG. 3 is a perspective view of a scanning device to advance media along a C-path 360. To advance media along a C-path 360, the input tray 310 is located vertically above the output tray 320. The ADF 330 advances media along the C-path 360 where the media first passes the lower scanning device 340 to first be scanned at a scan line of the lower scanning device 340. Then the media continues advancing along the C-path 360 and passes an upper scanning device 350 to be scanned at a scan line of the upper scanning device 350. The upper scanning device 350 may be located vertically above the lower scanning device 340. Then the media continues along the C-path and is output into the output tray 320.

Over the course of time, dust and debris is bound to build up over the scanning lines of the lower scanning device 340 and the upper scanning device 350. While advancing media may wipe over a scanning line of the lower scanning device 340, which may remove some dirt or debris on top of a scanning line of the lower scanning device 340, when advancing along the C-path, the media does not wipe over a scanning line of the upper scanning device 350.

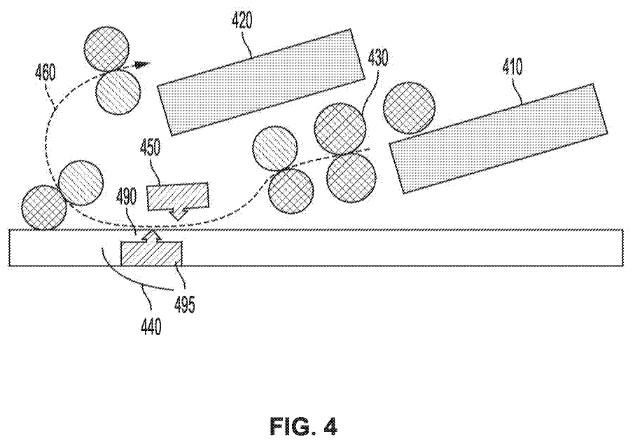

FIG. 4 is a perspective view of the media scanner 100 configured to advance media along an inverted C-path 460. As an example, a media scanner for scanning media may have a media feeder 430, such as an ADF, to advance the media along a media path 460 such as an inverted C-path. This media path leads the media from the input tray 410, to below the upper scanning device 450, to above the lower scanning assembly 440, and to the output tray 420. The upper scanning device 450 may be disposed at an angle with respect to the media path 460, to cause a front edge of the media advancing along the media path 460 to contact the upper scanning device 450 at or before a scan line 470 of the upper scanning device 450. The upper scanning device 450 may be disposed at an angle with respect to a lower scanning assembly 440. This causes the advancing media to contact the upper scanning device 450 to move dust and debris away from the scan line 470 of the upper scanning device 450. These features in combination have been shown to dramatically reduce the buildup of dust and debris on the scan line 470 of the upper scanning device 450. The upper scanning device 450 having less dust and debris at the scan line 470 of the upper scanning device 450 may help reduce the appearance of undesirable streaks in the scanned image or printed copy of the media. In addition, the removal of dust and debris from the upper scanning device 450 at the scan line 470 of the upper scanning device 450 may reduce how often the upper scanning device needs to be cleaned, resulting in less downtime for the media scanner.

As an example, the media scanner may include an input tray 410, an output tray 420 disposed above the input tray, a media feeder 430 to advance media along a media path 460 from the input tray to the output tray, an upper scanning device 450 to generate a first scan line 470, and a lower scanning assembly 440. The upper scanning 450 device may be disposed to face downward to scan a first side of the media. The lower scanning assembly 440 may be disposed vertically below the upper scanning device 450 and may be disposed to face upward to scan a second side of the media. The media path 460 extends from the input tray 410 to below the upper scanning device 450, to above the lower scanning assembly 440, and to the output tray 420. The upper scanning device 450 may be disposed at an angle with respect to the media path 460 to cause a front edge of the media advancing along the media path 460 to contact the upper scanning device 450 at or before the first scan line 470.

The output tray 420 is located vertically above the input tray. The ADF 430 advances media from the input tray 410 along the inverted C-path to pass an upper scanning device 450 first to be scanned at a scan line 470 of the upper scanning device 450. The location of the automatic document feeder 430 is a non-limiting example and may be placed at various other locations and may include additional rollers to advance the media long the inverted C-path. Then the media continues advancing along the inverted C-path 460 and passes a lower scanning assembly 440 to be scanned at a scan line 480 of the lower scanning assembly 440. The upper scanning device 450 may be located vertically above the lower scanning assembly 440. Then the media continues along the inverted C-path and is output into the output tray 420.

The upper scanning device 450 may include a lower surface that may be transparent such that light may freely pass through the lower surface. The lower surface may be a pane of transparent glass, but may also be other types of transparent materials. The upper scanning device 450 may comprise any suitable device or collection of devices that are to scan a surface or side of media during operations. For example, upper scanning device 450 may include a camera or collection of cameras that capture an image of a side of media.

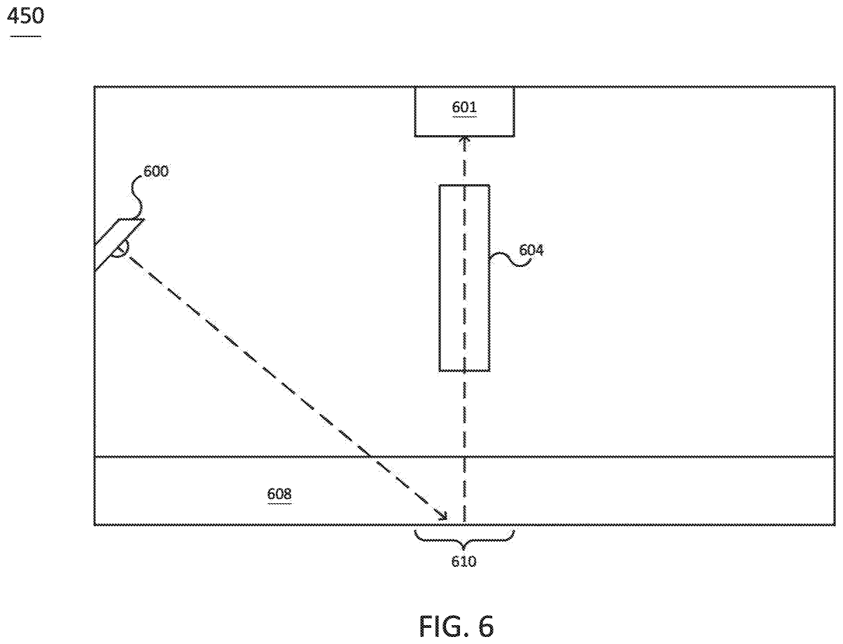

The upper scanning device 450 may include any suitable device or collection of devices that are to scan a surface or side of media during operations. The upper scanning device 450 may include a camera or collection of cameras that capture an image of a side of media. The upper scanning device 450 may include a contact image sensor (CIS) module, a reduction optics module, or some other combination of optics. The upper scanning device 450 may include optics for scanning a first side of media advancing along the media path 460. The upper scanning device 450 may include a CIS module as further illustrated in FIG. 6. The upper scanning device 450 may generate a scan line 470 along which the first side of the advancing media is scanned.

As an example, with reference to FIG. 6, the upper scanning device 450 may include a light source 600, a focusing mechanism 604, a sensor 606, and a transparent platen 608, and may generate a scan line 610.

The lower scanning assembly 440 includes a lower scanning device 495. The lower scanning assembly 440 may also include a transparent platen 490.

The lower scanning assembly 440 includes optics for scanning a second side of media advancing along the media path 460. The lower scanning assembly 440 may include any suitable device or collection of devices that are to scan a surface or side of media during operations. For example, lower scanning assembly 440 may include a camera or collection of cameras that capture an image of a side of media. The lower scanning assembly 440 may include a contact image sensor (CIS) module, a reduction optics module, or some other combination of optics. The lower scanning assembly 440 may generate a scan line 480 along which scanning of the second side of the advancing media is scanned.

The transparent platen 490 may include a first or upper surface and a second or lower surface. The transparent platen 490 may be transparent such that light may freely pass through the surfaces of the transparent platen 490 during operations. One example of a transparent platen 490 is a pane of transparent glass. However, other types of transparent materials may be used as the transparent platen 490.

The upper scanning device 450 may be disposed to face downward to scan a first side of the media at the scan line 470 of the upper scanning device 450. The first side of the media may be the front side of the media. The lower scanning device 440 may be disposed to face upward to scan a second side of the media at the scan line 480 of the lower scanning device 440. The second side of the media may be the back side of the media. In an example, the scanning side of the upper scanning device 450 faces the scanning side of the lower scanning assembly 440.

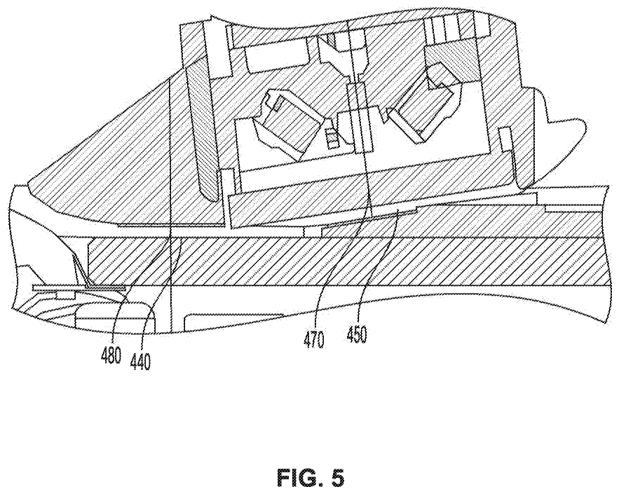

FIG. 5 is a zoomed-in perspective of the scanning device in FIG. 4. The upper scanning device 450 is disposed at an angle with respect to the media advancing along the inverted C-path to cause a front edge of the media advancing along the inverted C-path to contact the upper scanning device 450 at or before passing the scan line 470 of the upper scanning device 450. The upper scanning device 450 may be disposed at an angle with respect to a lower scanning assembly 440. As an example, the media contacting the lower surface of the upper scanning device 450 at or before passing the scan line 470 of the upper scanning device 450 may cause the advancing media to contact and wipe across the lower surface of the upper scanning device 450 at or before the scan line 470 of the upper scanning device 450. This may then remove dust and debris from the lower surface of the upper scanning device 450 at or before the scan line 470 of the upper scanning device 450.

The advancing media then may proceed to contact the upper surface of the lower scanning assembly 440 before passing the scan line 480 of the lower scanning assembly 440. As an example, the media contacting the platen 490 of the lower scanning assembly 440 at or before passing the scan line 480 of the lower scanning assembly 440 may cause the advancing media to hit and wipe across the scan line 480 of the lower scanning assembly 440. This may then remove dust and debris from the lower scanning assembly 440 at the scan line 480 of the lower scanning assembly 440.

In an example, the lower scanning device 495 may be located in close proximity to the upper scanning device 450. In an example, the lower scanning device 495 may be located 4.5 mm to 7.0 mm vertically apart from the upper scanning device 450. In an example, the lower scanning device 495 may be located within 6.0 mm vertically of the upper scanning device 450. In an example, the lower scanning device 495 may be located within 5.5 mm vertically of the upper scanning device 450. In an example, the lower scanning device 495 may be located within 5.0 mm vertically of the upper scanning device 450. In an example, the focal distance of the upper scanning device 450 may be within 2.5 mm of the focal distance of the lower scanning assembly 440. In an example, the platen 490 of the lower scanning assembly 440 may be located between 0.5 mm and 1.8 mm vertically of the upper scanning device 450. In an example, the platen 490 of the lower scanning assembly 440 may be located within 1.5 mm vertically of the upper scanning device 450. In another example, the platen 490 of the lower scanning assembly 440 may be located within 1 mm vertically of the upper scanning device 450. In another example, the platen 490 of the lower scanning assembly 440 may be located within 0.5 mm vertically of the upper scanning device 450.

In an example, the scan line 470 of the upper scanning device 450 may be between 10 mm and 25 mm horizontally apart from the scan line 480 of the lower scanning assembly 440. In an example, the scan line 470 of the upper scanning device 450 may be within 13 mm horizontally of the scan line 480 of the lower scanning assembly 440. In another example, the scan line 470 of the upper scanning device 450 may be within 10 mm horizontally of the scan line 480 of the lower scanning assembly 440. In another example, the scan line 470 of the upper scanning device 450 may be within 17 mm horizontally of the scan line 480 of the lower scanning assembly 440. In another example, the scan line 470 of the upper scanning device 450 may be within 22 mm horizontally of the scan line 480 of the lower scanning assembly 440. When the lower scanning device 440 is located in close proximity to the upper scanning device 450, each side of the advancing media can be scanned at similar times.

In an example, the upper scanning device 450 is disposed at an angle of 5 to 18 degrees with respect to the front edge of the media advancing along the inverted C-path. In another example, the upper scanning device 450 is disposed at an angle of 6 to 10 degrees with respect to the front edge of the media advancing along the inverted C-path. In another example, the upper scanning device 450 is disposed at an angle of 7 to 9 degrees with respect to the front edge of the media advancing along the inverted C-path. In another example, the upper scanning device 450 is disposed at an angle of 8 degrees with respect to the front edge of the media advancing along the inverted C-path.

The foregoing examples are merely examples and are not to be construed as limiting the disclosure. The disclosure can be readily applied to other types of apparatuses. Also, the description of the examples of the disclosure is intended to be illustrative, and not to limit the scope of the claims.

While the disclosure has been described with reference to the accompanying drawings, it is to be understood that the scope of the disclosure is defined by the claims described hereinafter and should not be construed as being limited to the above-described examples and/or drawings. It is to be clearly understood that improvements, changes, and modifications that are obvious to those skilled in the art are also within the scope of the disclosure as defined in the claims.

What is claimed is:

1. A media scanner comprising:
an input tray;
an output tray, the output tray being disposed above the input tray;
a media feeder to advance media along a media path from the input tray to the output tray;
an upper scanning device to generate a first scan line, the upper scanning device being disposed to face downward to scan a first side of the media at the first scan line; and
a lower scanning assembly to generate a second scan line, the lower scanning assembly being disposed vertically below the upper scanning device and is to face upward to scan a second side of the media at the second scan line,
wherein the media path extends from the input tray to below the upper scanning device, to above the lower scanning assembly, and to the output tray, and
wherein the upper scanning device is disposed at an angle with respect to the media path to cause a front edge of the media advancing along the media path to contact the upper scanning device at or before the first scan line.

2. The media scanner of claim 1, wherein a lower surface of the upper scanning device faces the upper surface of the lower scanning assembly.

3. The media scanner of claim 2, wherein the lower surface of the upper scanning device is disposed at an angle with respect to the upper surface of the lower scanning assembly.

4. The media scanner of claim 1, wherein the media advancing along the media path is to contact the lower scanning assembly at or before the second scan line.

5. The media scanner of claim 1, wherein the lower scanning assembly includes a scanning device and a transparent platen.

6. The media scanner of claim 1, wherein the angle the upper scanning device is disposed with respect to the media path is between 7 degrees and 10 degrees.

7. The media scanner of claim 1, wherein the angle the upper scanning device is disposed with respect to the media path is between 8 degrees and 9 degrees.

8. An image forming device, comprising:
a printer to print images on a recording medium; and
a media scanner coupled to the printer, wherein the media scanner comprises:
an input tray;
an output tray, the output tray being disposed above the input tray;
a media feeder to advance media along a media path from the input tray to the output tray;
an upper scanning device to generate a first scan line, the upper scanning device being disposed to face downward to scan a first side of the media at the first scan line; and
a lower scanning assembly to generate a second scan line, the lower scanning assembly being disposed vertically below the upper scanning device and is to face upward to scan a second side of the media at the second scan line,
wherein the media path extends from the input tray to below the upper scanning device, to above the lower scanning assembly, and to the output tray, and
wherein the upper scanning device is disposed at an angle with respect to the media path to cause a front edge of the media advancing along the media path to contact the upper scanning device at or before the first scan line.

9. The image forming device of claim 8, wherein a lower surface of the upper scanning device faces the upper surface of the lower scanning assembly and the lower surface of the upper scanning device is disposed at an angle with respect to the upper surface of the lower scanning assembly.

10. The image forming device of claim 8, wherein the lower scanning assembly includes a scanning device and a platen.

11. The image forming device of claim 8, wherein the media advancing along the media path is to contact the lower scanning assembly at or before the second scan line.

12. The image forming device of claim 8, wherein the angle the upper scanning device is disposed with respect to the media path is between 7 degrees and 10 degrees.

13. The image forming device of claim 8, wherein the angle the upper scanning device is disposed with respect to the media path is between 8 degrees and 9 degrees.

14. A media scanner comprising:
an input tray;
an output tray, the output tray being disposed above the input tray;
a media feeder to advance media along an inverted C-path from the input tray to the output tray;
an upper scanning device to scan a first side of the media; and
a lower scanning assembly to scan a second side of the media,
wherein the upper scanning device is disposed vertically above the lower scanning assembly and is disposed at an angle with respect to the media path to cause a front edge of the media advancing along the media path to contact the upper scanning device at or before the media is scanned by the upper scanning device.

15. The media scanner of claim 14, wherein the angle the upper scanning device is disposed with respect to the media path is between 7 degrees and 10 degrees.
